(19) United States
(12) Patent Application Publication
(10) Pub. No.: US 2010/0230284 A1
(43) Pub. Date: Sep. 16, 2010

(54) REAGENT DEVICES

(75) Inventor: Peter Kevin Stephenson, Yarnton (GB)

Correspondence Address: DARBY & DARBY P.C., P.O. BOX 770, Church Street Station, New York, NY, 10008-0770, US

(73) Assignee: F. Hoffmann-La Roche AG

(21) Appl. No.: 12/532,510

(22) PCT Filed: Mar. 20, 2008
(86) PCT No.: PCT/GB08/01005

§ 371 Date: May 24, 2010

(30) Foreign Application Priority Data
Mar. 24, 2007 (GB) 0705699.7

(51) Int. Cl. G01N 27/26; G01N 27/403; B01L 3/00; B05D 1/00

(52) U.S. Cl. 204/403.01; 422/102; 204/400; 422/100; 422/101; 422/82.01; 427/2.13

(57) ABSTRACT

A reagent device such as an electro-chemical micro-electrode sensor is provided with one or more reagent modules to carry respective reagents. The device includes respective receiving stations for receiving the reagent modules on board. The reagent modules may be tested independently before assembly of the device and hence yields are improved.

The present invention relates to reagent devices and methods of manufacturing such devices.

The invention has particular application and utility in relation to devices incorporating reagents for sampling and testing of fluids, such as, in particular biological fluids. Specifically the invention can be utilised in an electro-chemical device more particularly a microelectrode biosensor device having an array of sampling wells containing respective reagent substances.

WO03/056319 discloses an electro-chemical micro-electrode sensor having an array of wells or other sites which is used for analysing fluids including biological fluids (for example blood) or non biological fluids. The arrangement disclosed requires the fluid to be screened to be delivered to the one or more wells or other sites to be analysed and an electrical output produced. The quantities of fluid delivered for screening are at the level of micro litre volumes. A further example of a micro-electrode sensor for use in bioapplications is disclosed in US2005/0072670.

Typically in multi-analyte devices, different reagents are present at the wells or other sites and manufactured in techniques where the different reagents are introduced simultaneously or sequentially to the device. There are problems in obtaining adequate manufacturing yields of such devices, because a problem with composition or efficacy of one of the reagents in the wells results in rejection of the entire device, even if the reagents in the other wells of the device are satisfactory.

An improved technique and device have been devised.

According to a first aspect, the present invention provides a reagent device comprising:
One or more discrete reagent modules provided with a reagent substance; and a receiving station for receiving the respective reagent module positioned onboard the device.

In one embodiment, the reagent modules may be provided with means for mating with a structure onboard the device for location or securing with respect to the device.

This may be achieved by the modules having means for mating with one another for location or securing with respect to one another. In such an arrangement, one module provides a respective receiving station for receiving another reagent module positioned onboard the device.

The mating means comprise complementary engagement formations on the respective modules or structures.

The mating means may comprise interlocking formations, arranged to prevent mated modules from being separated from one another (or an onboard structure) in a specific separation direction.

In one embodiment of a reagent device according to the invention, respective modules may include one or more respective reagent zones and an electrode track arrangement.

The discrete reagent module preferably comprises a discrete structure incorporated in the reagent device. The reagent module is beneficially incorporated in the reagent device structure with reagent substance already present in the respective module.

In a preferred embodiment, the reagent module comprises a receptacle or well. The receptacle or well may contain the reagent substance and may also serve as a container for a fluid investigation sample (typically biological fluid). In some embodiments the receptacle or well is open topped.

The device may comprise a micro fluidic device configured to receive micro litre fluid volumes (or less) of an investigation sample to be received in the reagent module. The reagent module is adapted to accommodate micro litre fluid sample volumes, in the range 0.1 micro litres to 50 micro litres. The device preferably includes an investigation sample receiving station. The device advantageously includes a filter arrangement for filtering an investigation sample.

Beneficially the device comprises an electrode sensor and the reagent module includes an electrical contact for contacting with an electrode of the reagent device. In such and other circumstances the reagent substance may beneficially comprise an electro-active substance.

In one embodiment the receiving station may comprise a receiving socket formed in the reagent device structure. The module may be secured with the device by any convenient means and may be, for example a push fit in the socket. Additionally, or alternatively, a specific securing, locking or detent arrangement may be provided for securing the module with respect to the receiving station.

The connection between the reagent module and the device may be such that the reagent module can be demounted from the device following initial securing.

It is preferred that a plurality of discrete reagent modules are provided, beneficially each separate module containing a single reagent body only. Desirably, each separate module contains a respective single receptacle or well only. In a preferred embodiment different respective reagent modules are provided with different variety solid form reagents. The different reagents may be selected to test for different substances.

According to a further aspect, the invention provides a reagent module for use in an electrochemical electrode sensor and comprising a reagent substance in solid form.

Preferred features of the reagent module are as herein described.

According to a further aspect, the present invention provides a method of manufacturing a reagent device comprising positioning a discrete reagent module onboard the device at a module receiving station, the reagent module incorporating a reagent substance.

Desirably, the reagent substance is incorporated into the reagent module prior to the module being positioned or secured onboard the device.

In one embodiment, the reagent substance may be introduced to the module in liquid form and subsequently changes to solid form. The reagent substance may be introduced to the module in liquid form and subsequently freeze-dried.

In an alternative embodiment the reagent substance may be introduced in powder form, or as a mixture, frit or otherwise.

It is preferred that a plurality of separate discrete reagent modules are positioned onboard the device, the separate modules incorporating reagent substance. Beneficially separate modules incorporate different reagent substances. In certain embodiments, as mentioned previously, it is desirable that the reagent substance or substances is or are electro-active substances.

For micro fluid biosensor applications it is preferable that the reagent substance is present in a respective module in a micro volume dose in the range 20 nano litres to 1000 nano litres (more preferably in the range 50 nano litres to 700 nano litres, most in the range 100 nano litres to 600 nano litres).

According to a further aspect, the invention may provide a method of manufacturing a reagent device comprising:

obtaining a discrete solid form dose of a reagent substance from a starting material (by means of freeze drying, or otherwise);
Positioning the discrete solid form reagent dose onboard the device at a receiving station.

A significant benefit of the present invention is that respective reagent modules can be dosed separately and tested non-destructively separately (prior to mounting/assemblage in the device) in order to ensure that, where a respective reagent module does not comply with test requirements it can be discarded without the necessity to discard other reagent modules or components of a reagent device. This provides significant advantage in terms of overall production yields in that it enables components not passing relevant testing to be discarded without necessarily discarding the entire assembled reagent device.

The invention will now be further described, by way of example only, and with reference to the accompanying drawings, in which:

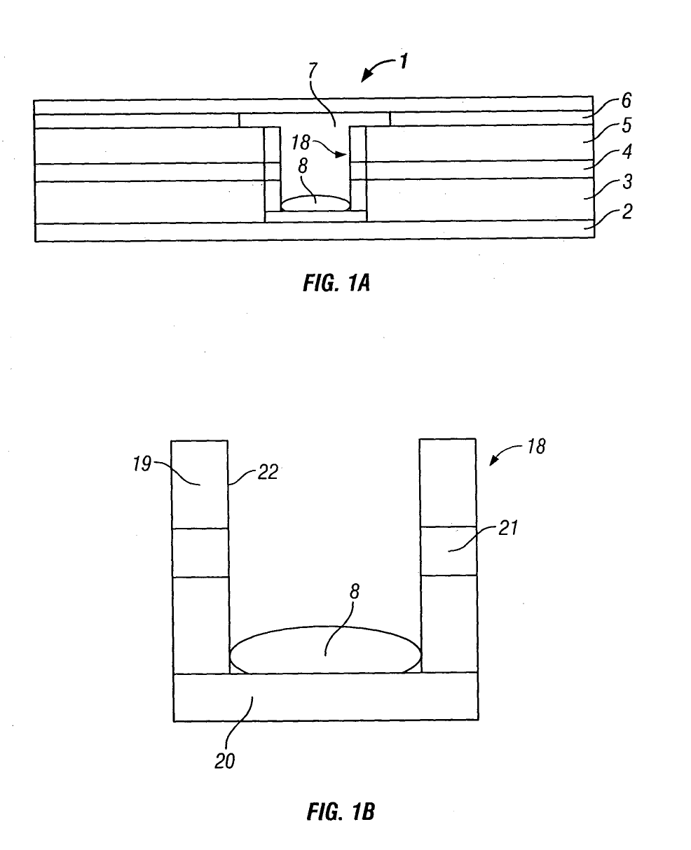

FIG. 1A is a schematic view of an electrochemical cell comprising a reagent device in accordance with the invention;

FIG. 1B is a schematic view of a reagent module incorporated in the device of FIG. 1 A;

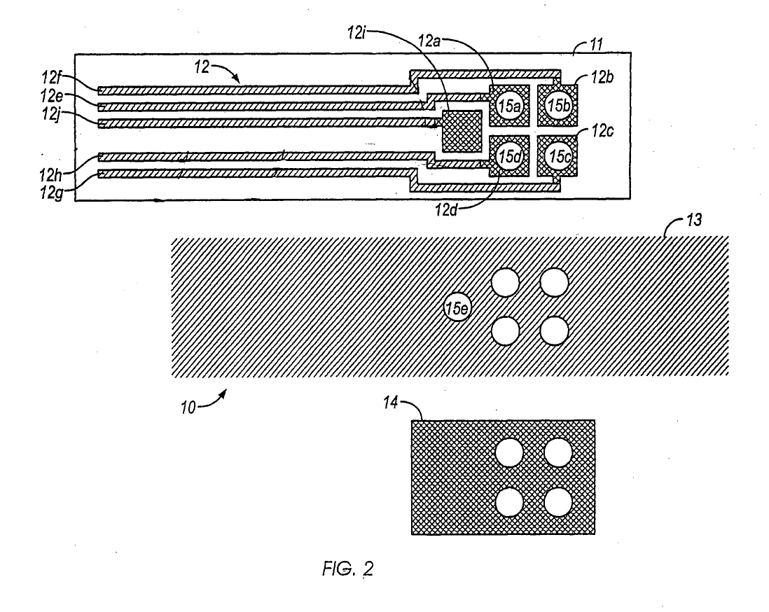

FIG. 2 is a schematic plan representation of a sensor strip device in accordance with the invention comprising four electrochemical cells;

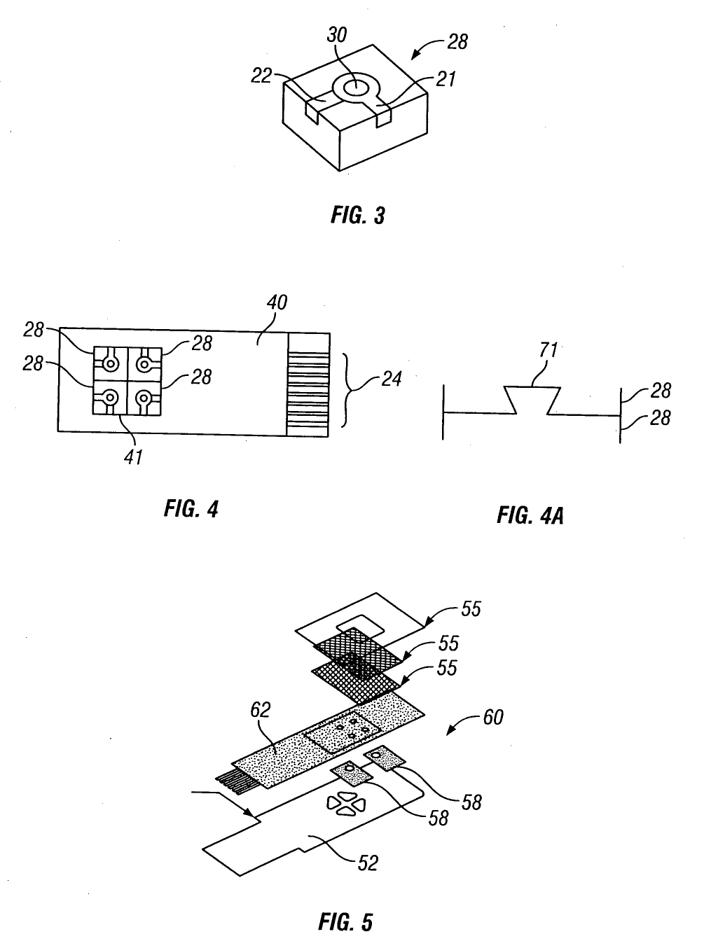

FIG. 3 is a schematic view of an alternative reagent module in accordance with the invention;

FIG. 4 is a schematic view of a reagent device including an array of the modules of FIG. 3;

FIG. 4A is a schematic view of a mechanical interlocking connection between adjacent modules; and

FIG. 5 is a schematic view of an alternative embodiment of a reagent device according to the invention.

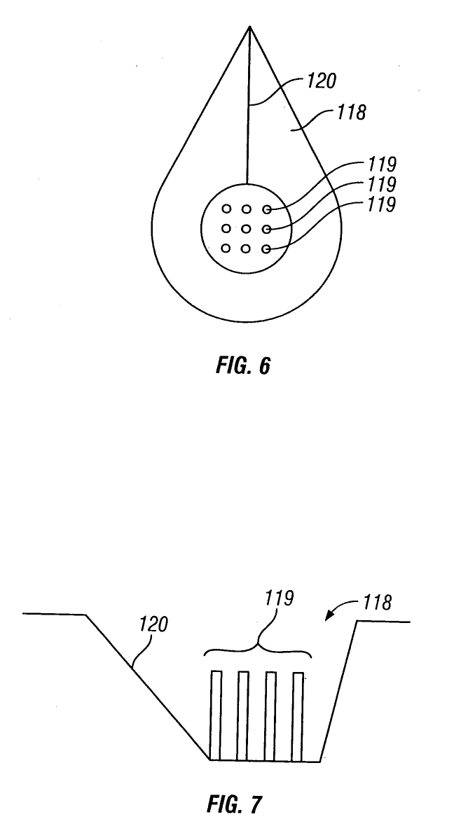

FIG. 6 is a plan view of a reagent well containing microstructures;

FIG. 7 is a schematic sectional view of the well of FIG. 6.

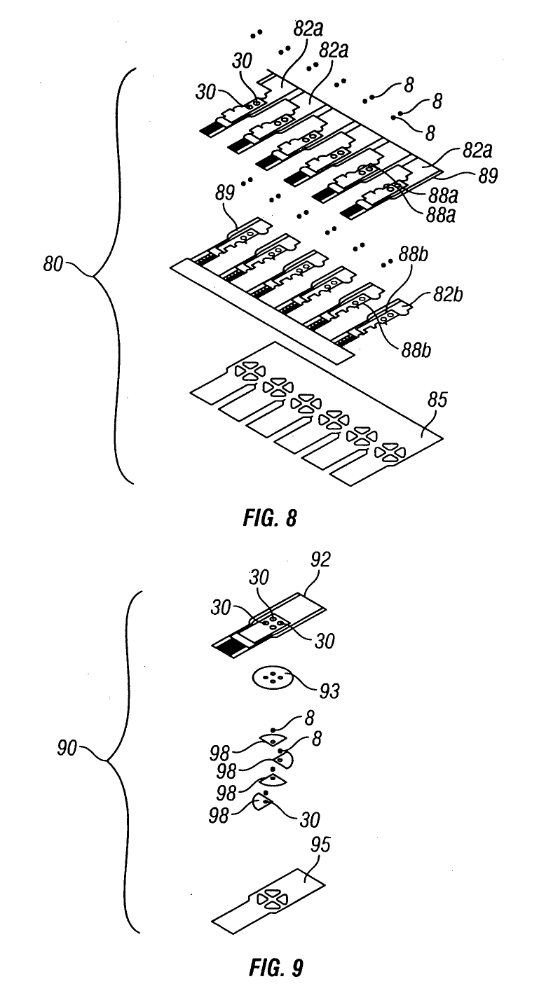

FIG. 8 is a schematic view of assembly of an alternative arrangement of reagent device according to the invention;

FIG. 9 is a schematic view of assembly of an alternative embodiment of a reagent device according to the invention;

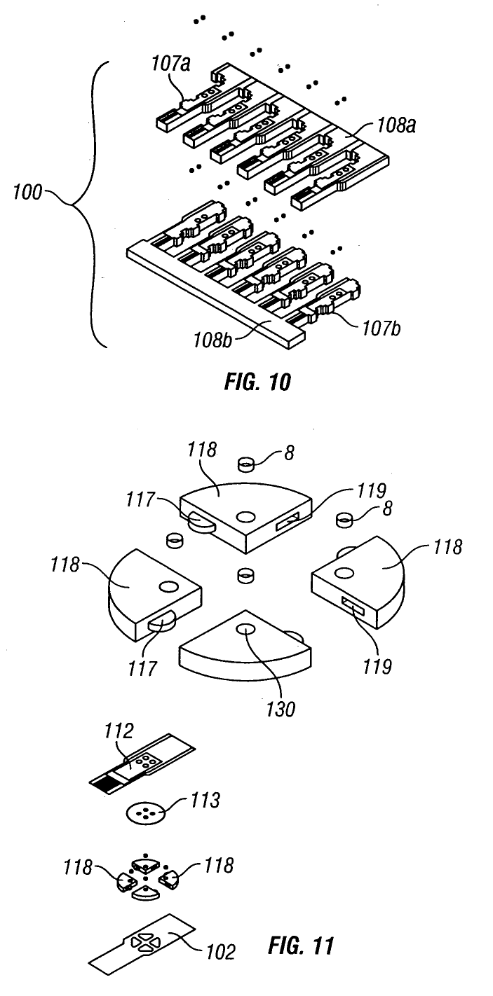

FIG. 10 is a schematic view of assembly of an alternative embodiment of a reagent device according to the invention;

FIG. 11 is a schematic view of assembly of an alternative embodiment of a reagent device according to the invention.

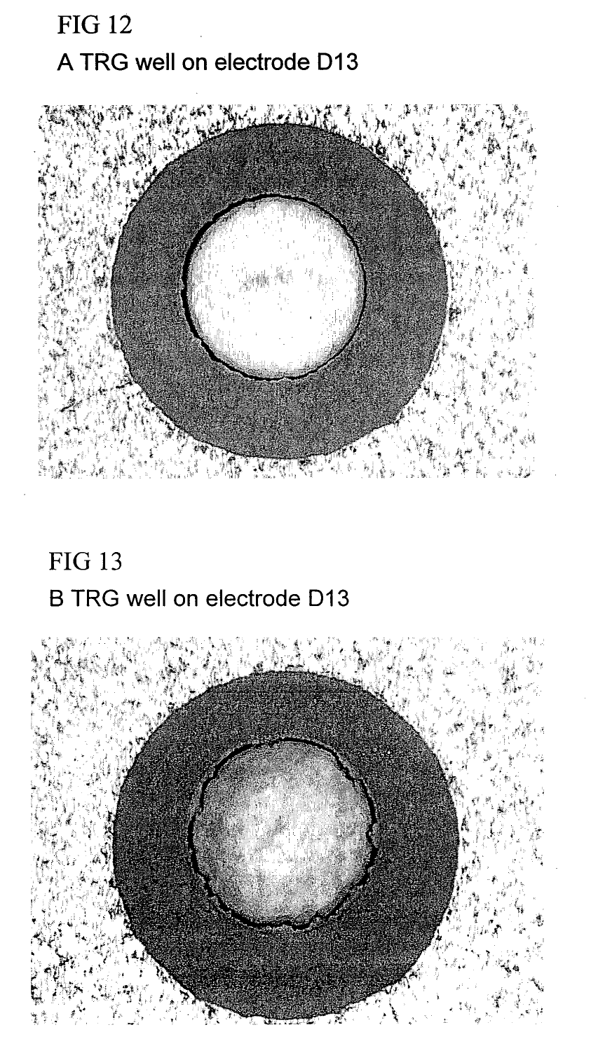

FIG. 12 is a photo image of a first deposited reagent structure;

FIG. 13 is a photo image of a second deposited reagent structure;

Referring now to FIGS. 1 and 2 of the accompanying drawings, an electrochemical device structure 1, illustrated in a cross sectional side view, comprises a layer 2 formed from a non-conducting porous material preferably hydrophobic. The layer 2 preferably has a thickness of 25-300 μm, preferably around 50 μm.

A non-conducting supporting layer 3 is attached to the base layer 2. The supporting layer 3 is preferably formed from PET and has a thickness in the range of 5 μm to 500 μm, preferably 50-300 μm, more preferably 125-250 μm.

The supporting layer 3 forms a support on which a working electrode 4 is formed. The thickness of the working electrode 4, which is its dimension in a vertical direction when the cell 1 is placed on the base 2, is typically from 0.01 to 50 micro meters. Preferred and other possible thicknesses of the working electrode are as described in our co-pending application WO 03/056319.

The working electrode 4 is preferably formed from carbon, for example in the form of conducting ink. A preferred carbon based conducting ink comprises a suspension of carbon dispersed in a resin solution. The working material may be formed of other materials and inks as detailed in WO 03/056319. Furthermore, two or more layers of the same or different materials may be used to form the working electrode.

A dielectric layer 5 comprising an insulating material typically a polymer, a plastic or ceramic again as detailed in WO 03/056319 is formed on and insulates the working electrode 4 from a pseudo-reference electrode 6. Typically, the dielectric layer 5 is of thickness 1 to 200 μm. The dielectric layer could be formed of more than one layer.

The pseudo-reference electrode 6 in a preferred embodiment comprises silver/silver chloride and forms part of the top of the cell 1. Preferably the material of the electrode 6 is provided in the form of a conductive ink and the pseudo-reference electrode 6 has a thickness of the order of 5 microns or greater. A range of possible materials, inks and thicknesses suitable for the pseudo-reference electrode are also discussed in WO 03/056319.

In order to manufacture the cell, 1 the layers are deposited in a layer by layer fashion. In a preferred embodiment a working electrode 4 preferably formed of carbon is screen printed on the supporting layer 3 and the dielectric layer 5 is printed on the working electrode 4. The dielectric layer 5 may be printed as two layers so that any pin-holes that occur in the first layer of printing are filled. The pseudo-reference electrode 6, preferably formed of silver/silver chloride is screen printed on the dielectric layer 5. Laser drilling, mechanical punching or other drilling means is used through the dielectric layer 5, the working electrode 4 and the supporting layer 3 in order to form a receiving station 7 (in the form of a cylindrical socket).

During manufacture of the device structure 1 a reagent module 18 is inserted into the receiving station 7 as a push fit in order to ensure adequate securing of the module 18 on board the device structure. In the embodiment shown, the reagent module 18 comprises a walled receptacle well having an external cylindrical plastics wall 19 and an internal cylindrical wall surface 22. The reagent module has a porous base membrane 20. The reagent module 18 contains a solid form reagent dose 8. The volume of the reagent dose is typically, for micro fluid biosensor applications, in a micro volume dose in the range 20 nano litres to 1000 nano litres (more preferably in the range 50 nano litres to 700 nano litres, most in the range 100 nano litres to 600 nano litres).

The wall of the reagent module 18 includes a conductive contact 21 extending from the internal surface of the reagent module 18 to contact the working electrode 4 when the reagent module is docked in position in the socket form receiving station 7. The pseudo-reference electrode 6 ends around 0.4 to 0.5 mm from the edge of the reagent module. Well diameters of 0.1 mm to 5 mm may be utilised dependent upon a particular application. Where non-circular wells are used, the length or width dimension will typically be in the range 0.1 mm to 5 mm (more typically 0.9 to 1 mm). Typically the well depth will be in the range 50 μm to 1000 μm, more typically 200 μm to 800 μm, most typically 300 μm to 600 μm. Circular or non circular reagent module external wall geometries may be utilised. Geometric shapes such as square or hexagonal may be preferred for the outer profile of the reagent module 18 (enabling positive orientation of the module 18 in a complementary geometric shaped socket form receiving station 7), although a circular profile is described in this specific embodiment for ease of description

The base layer 2 is fixed to, for example by a suitable adhesive, to the un-printed side of the supporting layer 3 to produce the base of the device structure 1. The base layer 2 may take the form of a porous membrane containing air holes so that air in the well can be displaced when a measurement sample is introduced into the reagent module.

Preferably, the open end of the structure 1 is covered with a membrane 9 that is permeable to components of the sample to be tested, for example blood or plasma. The membrane may also be used to filter out components of the sample that should not enter the cell, for example red blood cells.

Referring now to FIG. 2 of the drawings, there is illustrated in a schematic plan view, layers of a multi analyte test array 10 comprising four electrochemical cells using four reagent modules 18 of the type described above.

The sensor strip 10 comprises an insulating substrate sheet 11. Formed on the insulating substrate sheet 11 is a patterned layer 12 of material that forms four working electrodes 12a, 12b, 12c and 12d, one for each of the respective four cells and four conductive tracks 12e, 12f, 12g and 12h each of which in electrical contact with a respective one of the four working electrodes 12a, 12b, 12c and 12d.

The patterned layer 12 also defines an additional pad 12i, a fifth conductive track 12j in electrical contact with the additional pad 12i and an additional conductive track 12k.

In a preferred embodiment the patterned layer 12 is formed from carbon and is screen printed on the insulating substrate sheet 11.

The four cells each further comprises a dielectric insulating layer 13 deposited over the four working electrodes 12a, 12b, 12c and 12d and a pseudo-reference electrode layer 14, in a preferred embodiment formed from silver/silver chloride and screen printed on the dielectric layer 13.

It will be appreciated that for ease of viewing the various layers, the dielectric layer 13 and the pseudo-reference electrode layer 14 are each illustrated shifted laterally sideways from their true positions in the strip 10.

Each of the four cells further comprises a respective one of four holes 15a, 15b, 15c and 15d formed through the, the dielectric layer 13 its respective working electrode 12a, 12b, 12c and 12d and the supporting layer 11 ending at a base layer (not illustrated) to form wells 8. The holes 15a, 15b, 15c, 15d, define the location of socket form receiving stations 7 for receiving respective reagent modules 18.

A fifth hole 15e is printed on the dielectric layer 13 to the additional pad 12i. The pseudo-reference electrode 14 makes electrical contact with the additional pad 12i.

Each of the four conductive tracks 12e, 12f, 12g and 12h allows the respective working electrode 12a, 12b, 12c and 12d with which it is in electrical contact to be placed in a circuit with the pseudo-reference electrode 14, measuring instruments and voltage sources.

An electro-active substance 8 is contained within the receptacle well of a respective reagent module 18. The electro-active substance 8 may be freeze dried to form a porous cake, but by virtue of the present invention the reagent is introduced into the respective reagent modules 18 prior to introduction of the modules into the device structure 1. On introduction of a measurement sample (not shown) into the receptacle well of the reagent module 18, the electro-active reagent substance 8 dissolves and an electrochemical reaction may occur and a measurable current, voltage or charge arises in the cell. Electro-active reagent substances are discussed in more detail in, for example our co-pending application WO 03/056319.

The sensor arrays 10 are formed on a base sheet 30 which acts as a substrate for a large number of strips 10 arranged for example in an 18×7 row and column matrix. The substrate base sheet 30 may comprise the PET base layer 2 of the respective cells when the strips 10 are eventually divided from the base sheet.

In the embodiment of a reagent module 28 shown in FIGS. 3 and 4, the reagent module 28 is square in perimeter profile and comprises a solid body (which may be porous) having a central well 30 containing a specific dosed reagent. A working electrode contact 21 is provided for connecting with the external connector contacts 24. A reference electrode contact 22 is also provided for connecting with the external connector contacts 24.

The strip 40 is provided with a single square recessed central docking perimeter 41 within which the four discrete square perimeter reagent modules 28 are arranged to be received. The perimeter of the docking area 41 is provided with contacts correspondingly positioned to contact the working electrode contacts 21 and reference electrode contacts 22. The contacts may either connect to the top of the modules or the sides of the modules. In embodiments where the contacts are connected to the top of the modules a 2D printed connector can be used.

The four reagent modules can each be positioned (for example using suitable pick and place apparatus) in the appropriate position in the docking perimeter 41. The modules can be provided with interlocking or mating structural portions in order to mechanically secure to one another or the device. For example, press fit, jigsaw, or other interlocking formations 71 may be provided as shown in FIG. 4A.

Referring now to FIG. 5, which shows a reagent device 60 in exploded form for ease of explanation, the reagent device comprises a multi-analyte test strip 60 made up as a layer structure and comprising a plastics base layer 52 and reagent modules 58 positioned to adhere to the base layer 52. In the example shown in FIG. 5, only two reagent modules are visible, however in fact, four modules 58 will be present. A printed electrode layer 62 overlays the base layer 52 and modules 58. The printed electrode layer 62 may be made up in accordance with the layer arrangement described in relation to the embodiment of FIG. 2, having a screen printed electrode layer sheet 11 and dielectric insulating layer 13. A sample deposition and filter layer arrangement 55 may be provided for receiving and filtering a fluid sample under test.

The invention enables that, where required, the reagent modules 18, 28 can be preformed with pre freeze dried (solid form) reagent 8 and are incorporated with the device structure during manufacture of the device structure. Typically the solid form electro-active reagent is obtained by freeze drying a dosed quantity of liquid form reagent (for example 0.4 micro litres). Also typically each of the four cells (i.e. each of the four modules 18, 28) will contain a different test electro-active reagent.

In another embodiment shown in FIGS. 6 and 7, the reagent may be incorporated into a non free standing structure, for example, a “frit” mixture or agglomeration created out of a porous polymer. Then, with the frit providing the structure, the reagent can be applied and dried in a variety of ways. The frit mixture or agglomeration can also be “powder loaded” rather than “wet dispensed”. A structure may be used in order to carry the reagent (such as for example a polymer structure, nylon mesh or the like) having an endoskeleton structure rather than an exoskeleton structure.

The reagent in frit mixture, powder, or other agglomerated form is dispensed into the well 118. The well 118 may contain microstructures, which aid the reagent re-suspension. Such microstructures may consist of columns 119 around which the reagent is dispensed and/or dried. The well may also include a lead-in groove 120 (or grooves) along which plasma can be made to preferentially flow into the well and around the microstructure arrangement (columns 119). In the embodiment shown, the well is ‘tear drop’ shaped in plan and the lead in groove 120 tapers downwardly from an apex of the well.

The present invention enables batch production and efficacy testing of the solid form electro-active reagent, prior to incorporation into the device structure.

This results in more efficient production and avoids problems in freeze drying of liquid reagents in situ in such a device structure, in circumstances where efficacy testing can only be carried out subsequent to drying of the reagent doses. In such circumstances one of the reagent doses may be found to be bad and result in scrapping of a batch of structures in which the other 3 of the four cells in each device structure are satisfactory.

In an alternative potential technique, in place of a reagent module 18 containing a freeze dried reagent, a solid reagent cake or other agglomeration, pellet tablet or the like may simply be introduced into the respective receiving stations 7 and may optionally be secured in place. This retains the advantage that the solid form reagent is presented during manufacture (typically subject to batch production and testing) rather than being freeze dried (or otherwise dried) from liquid form, in situ in the reagent well on board the device.

In the embodiment shown in FIG. 8 the reagent device 80 certain in similar in certain technical aspects to the device 50 of FIG. 5 and the arrangement as shown in the embodiment FIG. 2. In this embodiment the reagent wells 30 are provided in two-well modules 88a, 88b on each half 82a, 82b of the printed electrode layer which is provided in two separate halves.

In the arrangement shown the printed strip halves 82a 82b (each comprising a separate two-well module 88a, 88b) are provided as separate edge connected arrays each of which comprises a plurality (six as shown in the figure) of the relevant printed electrode strip halves. When matched up the left and right halves co-operate to provide a complete electrode printed strip. The respective strips are eventually divided from the array to be separated from one another in a final separation step

In laying up the structure during manufacture, the respective strip halves 82a, 82b are printed in their two respective halves 82a and 82b and the reagent wells 30 are then laser drilled. A mesh vent backing 89 is then provided on the underside of the respective strips which provide a bottom or base for the respective wells. Each printed half 82a, 82b is then profiled ready for assembly and then the reagent doses are deposited into the wells of each separate respective strip half 82a, 82b. Importantly, the deposition of the reagent (in solution, solid form or otherwise) takes place separately for each respective printed strip half. If necessary (for example where the reagent is deposited in solution) the relevant printed strip halves 82a, 82b are then freeze dried to ensure to ensure freeze drying of the dispensed reagent.

Respective strip halves 82a, 82b are then assembled (optionally to a base backing layer 85). A release liner is first removed from the base layer to permit exposure of the adhesive surface of the base layer 52. A alignment on the base layer 82 the release liner is profiled corresponding to the left and right strip halves such that the backing is only peeled to expose the sticky area where the respective strip half is being assembled. The other half of the release liner is then removed and the remaining strip half 82a/82b is adhered into position. This can be achieved either by subsequent application of the relevant material (for example silver ink applied by a relevant applicator or by hand) alternatively the printed tracks can be designed such that the connection is made when laying down the relevant strip halves 82a/82b.

In this arrangement (and other arrangements) the invention permits that, when the relevant reagent has been deposited in the wells and prior to assembly of both strip halves 82a, 82b (and therefore both two-well modules 88a, 88b), it is possible to non-destructively test the integrity of the relevant strip halves separately. This enables strip halves not passing the relevant test to be discarded, without the necessity for discarding other halves of the test strips, which have passed testing.

In the embodiment on FIG. 9 the reagent device 90 comprises four reagent modules 98, each provided as a respective circle segments including a respective well 30 receiving the reagent deposit cake 97 (either in solid form or in solution—subsequently freeze dried, or other form—for example frit form).

In this embodiment the relevant electrical tracks are printed on the substrate electrode layer 92 and the wells 30 are then drilled into the printed strip substrate 92.

A double sided adhesive patch 93 is drilled with holes to match up with the respective wells on the strip.

The separate circle segment well modules 98 are cut from card and provided with mesh vents to provide a base for each well. Separately the respective reagent doses (either in solution or subsequently freeze dried, solid form etc) are dispensed into the wells 30 in the circle segment well modules 98. The double sided adhesive patch 93 is then used to secure the respective modules 98 to the printed electrode strip 92 and an optional backing base layer 95 may then be applied to the underside of the assembly. The backing base layer 95 has a peelable release layer to reveal an adhesive layer on the base layer 95.

In this embodiment each of the respective reagent modules 98 can be dosed separately and tested non-destructively separately (prior to mounting/assemblage in the device) in order to ensure that, where a respective reagent module does not comply with test requirements it can be discarded without the necessity to discard other reagent modules or components of the reagent device.

In the embodiment of FIG. 10 the design is generally similar to the embodiment FIG. 8, however in this arrangement the relevant electrode printed strip half arrays 108a, 108b have a respective depth dimension (for example being formed of self supporting plastics material or alike) and the interface between respective strip halves is provided with an interlocking surface profile 107a/107b allowing the two halves to matingly engage one another on approaching one another in a first direction and interlocking so to as not to be able to be removed in a direction transverse to the direction of approachment. The interlocking is such that once interlocked, respective profiled portions abut one another so as to inhibit separation in at least one direction. A dovetail interlocking profile as shown in FIG. 4a may be used conveniently for this purpose.

The arrangement described permits respective doses of reagent to be dosed separately and independently (freeze dried if necessary) and backing applied before the two strip halves are brought together to make the final strip. The interlocking surface profile provides for secure and robust engagement and ease of assembly. Once the relevant strips have been assembled in these embodiments it will be necessary to operate a final cutting step to separate the respective strips from the array.

In the embodiment of FIG. 11, the arrangement is generally similar to the embodiment shown in FIG. 9, however in this embodiment the respective modules 118 are provided with respective tabs 117 and recess is 119 which are arranged to cooperatively mate with one another to assemble the respective modules into a self supporting assembly sufficient to enable securing to the respective electrode printed strip 112 utilising the double sided, well drilled adhesive patch 113. An optional base layer backing 102 may then be applied.

The arrangement of FIGS. 10 and 11 enabling locking together the relevant modules are envisaged as providing significant advantage in terms of assembly. The engagement of the profiled portions 107a/107b and the tabs 117 and recesses 119 may be a ‘push fit’ or ‘interference fit’, thereby ensuring that the assembly is sufficiently self supporting for practical purposes.

In the arrangements of certain embodiments, for example the embodiments of FIGS. 9 and 13, the double sided adhesive patch 93, 113 is provided as an exemplary means only of securing the reagent modules to the strip. Other arrangements (such as cages) are envisaged without departing from the scope of the invention. Similarly it will be appreciated that other technical realisations described in the embodiments shown in the drawings are merely exemplary. As a further example, the backing material base layer 2, 52, 85, 95, 102 should be considered as being merely an optional feature in certain realisations of the invention. Particularly when the strip fractions or the reagent modules are interlocking and/or self supporting a backing layer or base layer may generally not be required.

A significant advantage of the reagent devices of the present invention is that they enable the relevant modules and components of the device to be non-destructively tested separately prior to final assembly. This provides significant advantage in terms of overall production yields in that it enables components not passing relevant testing to be discarded without necessarily discarding the entire assembled reagent device. The modular testing followed by assembly of the device using only “test passing” reagent modules leads to a 100% yield rate. This can be compared with a system in which all four regent reagent samples are deposited or the strip and assembly is completed prior to testing. In such an arrangement, assuming a yield rate for each individually deposited reagent deposit (cake) of 50%, then the four deposit device would result in 6.25% yield only. This comparison emphasises the efficiency of the present invention.

The following are examples of possible non-destructive tests.

Visual inspection with respect to deposited reagent (cake) depth/height and/or brightness.

Electrical testing, for example with respect to short circuits and continuity and/or resistance of electrode.

Weight testing.

Fluorescence testing to establish degree of homogeneity of the reagent and/or activity of the enzyme.

### NON-DESTRUCTIVE TEST EXAMPLE

### Deposited Reagent (Cake) Appearance Measurement

This data shows good and bad freeze dried TRG cakes.

The cakes were pictured using an ‘OGP Smartscope’ camera system under standard, controlled lighting. The camera system had a calibrated focal length gauge which was used to determine the height of each of the cakes. Each picture was then analysed using an ‘ImageJ’ program that selects a predetermined area within the cake and counts the number of pixels with the same greyscale value, from 0=black to 255=white.

| Example | Cake Height | Cake Brightness | Quality |
|---|---|---|---|
| A | 0.310 mm | 240.0 | Good |
| B | 0.282 mm | 230.1 | Bad |

Example images are shown in FIGS. 12 and 13.

### PRODUCTION OF WORKING ELECTROCHEMICAL BIOSENSOR EXAMPLE

### Electrode Sheets

Standard sheets: Screen printed electrodes with laser drilled wells. Electrodes are as disclosed in WO200356319. These were modified document to produce strip half fragments in accordance with the present invention (in particular the arrangement of FIG. 8).

### Standard Total Cholesterol Sensor (TC)

### 0.1 M Tris pH 9

### 0.05 M MgSO₄

5% glycine

### 1% Ecotine

### 1% Inositol

80 mM Ruthenium Hexaamine trichloride
9 mM Thio nicotinamide dinucleotide

### 5% CHAPS

### 5% Deoxy-bigCHAPS

3.3 mg/ml Cholesterol esterase
4.2 mg/ml Putidaredoxin reductase
66 mg/ml cholesterol dehydrogenase

### Standard Triglyceride Sensor (TRG)

Approximate concentrations in final enzyme mix:

### 0.1M HEPBS Buffer pH 9

### 1% CHAPS

### 80 mM Ru(III)(NH₃)₆Cl₃

17.6 mM thio-nicotinamide dinucleotide (TNAD)

### 5% KCl

45 mg/ml GlyDH
6.5 mg/ml Diaphorase
50 mg/ml Lipase

### Production of Biosensor

The enzyme solutions were dispensed into the electrode fragments using a Genex Alpha 0.1-10 μl electronic pipette set to dispense 0.4 μls. The TC solution was dispensed into the wells of both right and left hand strips 82a/82b (version 1). TRG solution was also dispensed into the wells of both right and left hand strips 82a/82b (version 1). TC solution was dispensed into individual wells 98 (version 2) and TRG solution was dispensed into individual wells 98 (version 2).

All the strip fragments were immediately freeze dried—this can be accomplished with either a batch or a continuous freeze drier for example as disclosed in WO2007/066132. In these examples the freeze drying was accomplished using a batch freeze drier as detailed.

The strip fragments are placed in the freeze drier at atmospheric pressure and the freezing plates set to −30° C. Once the fragments are loaded the cycle is initiated and the temperature decreases reaching the minimum temperature of −37.5° C. in 43 minutes. After a further 50 minutes the vacuum is applied, the minimum vacuum of 4×10⁻² mbar been achieved after an additional 23 minutes. The vacuum is applied for a total of 1.5 hrs, after which the temperature in the chamber is increased at a rate of 0.5° C./min until +22° C. is reached. After the fragments have been at 22° C. under vacuum for 0.5 hrs they may be removed. To remove the fragments, the chamber is filled with dry nitrogen until atmospheric pressure is reached and the fragments retrieved and immediately transferred to a dry environment for further processing.

### Non-Destructive Testing

Once freeze dried, the fragments were visually inspected, both looking at cake height and brightness. Those fragments that passed this test were assembled into complete strips (reagent devices).

### FIG. 8 (Version 1)

All TC
All TRG
Two RHS wells TC and Two LHS wells TRG
Two LHS wells TC and Two RHS wells TRG

### FIG. 9 (Version 2)

All TC
All TRG

### Electrochemical Testing of Completed Sensors

The strips were tested by chronoamperometry using an Autolab (PGSTAT 12) and a multiplexer (MX452, Sternhagen Design). At T=0 seconds the chronoamperometry test was initiated using the multiplexer attached to the Autolab. 15 repeat oxidations at +0.15V for 1 second were performed, followed by a final reduction current at −0.45V for 1 second. There was a 15 second delay between oxidations which resulted in oxidations at approximately 0, 14, 28, 42, 56, 70, 84, 98, 112, 126, 140, 154, 168, 182, 196 and 210 seconds. Data was analysed for current values at 1 second on the transient using an in-house procedure. Plasma samples were used for all the testing. The plasma was analysed for its reference TC and TRG values on a spACE analyser.

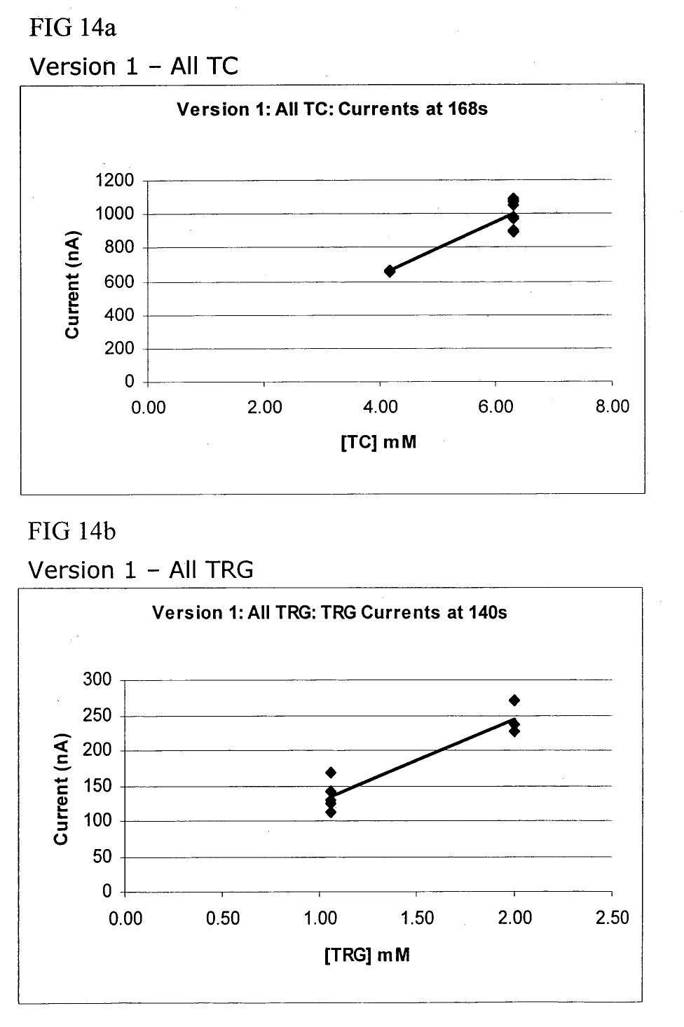

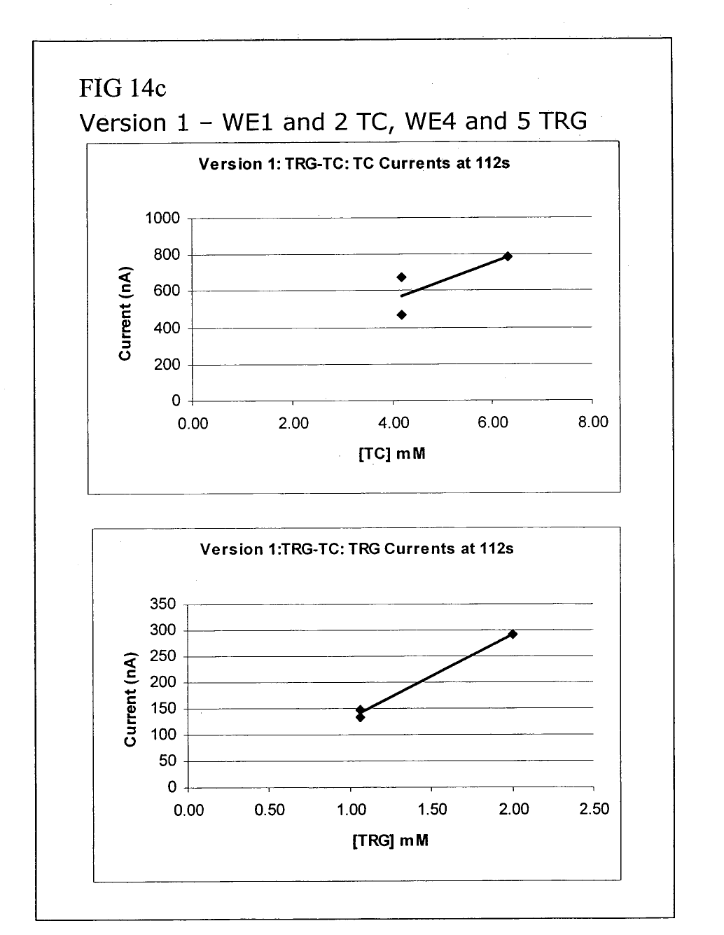

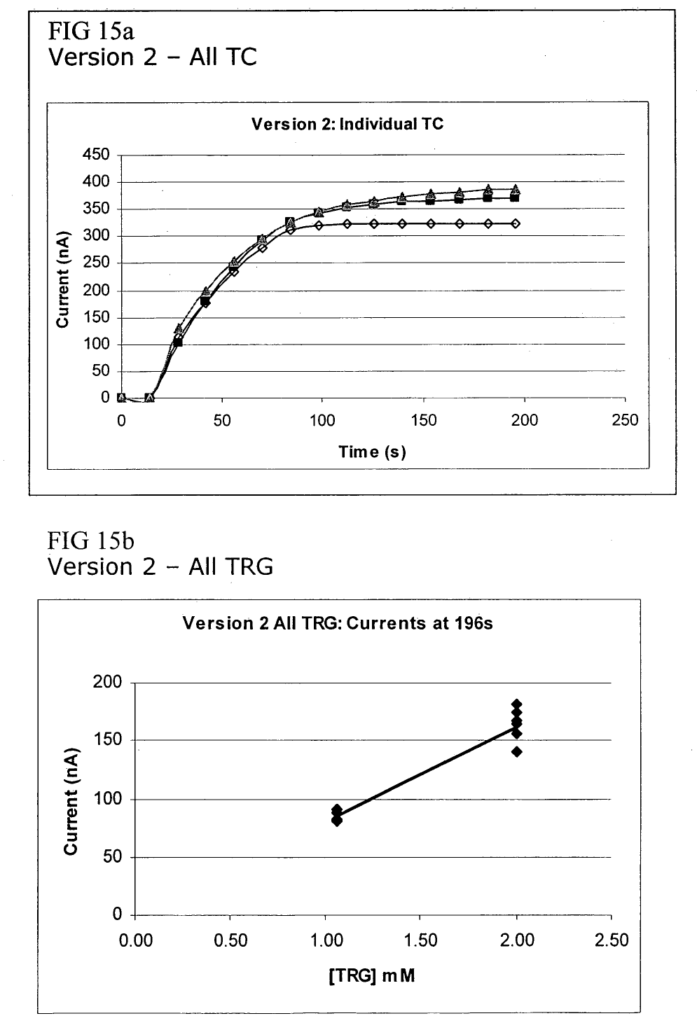

The results of the electrochemical testing of the completed working sensors are presented in FIGS. 14 and 15.

FIG. 14a is a Calibration plot of oxidation current versus the total cholesterol (TC) concentration for different human sera samples. Currents were recorded after an oxidation potential of +0.15 V (vs Ag/AgCl reference) was applied to the working electrode on a fully constructed Oxford Biosensors screen printed carbon micro-electrode strip fabricated according as detailed in FIG. 8 in which using an Autolab PGSTAT12 potentiostat/galvanostat (Eco Chemie, Netherlands) connected to a home-built multiplexer, controlled by the General Purpose Electrochemical System software (Eco Chemie, Netherlands). The measurements were taken after 168 s.

FIG. 14b is a Calibration plot of oxidation current versus the triglyceride (TG) concentration for different human sera samples. Currents were recorded after an oxidation potential of +0.15 V (vs Ag/AgCl reference) was applied to the working electrode on a fully constructed Oxford Biosensors screen printed carbon micro-electrode strip fabricated according as detailed in FIG. 8 using an Autolab PGSTAT12 potentiostat/galvanostat (Eco Chemie, Netherlands) connected to a home-built multiplexer, controlled by the General Purpose Electrochemical System software (Eco Chemie, Netherlands). The measurements were taken after 140 s.

FIG. 14c is a Calibration plot of oxidation current versus the triglyceride (TC) and total cholesterol (TC) concentration for different human sera samples. Currents were recorded after an oxidation potential of +0.15 V (vs Ag/AgCl reference) was applied to the working electrode on a fully constructed Oxford Biosensors screen printed carbon micro-electrode strip fabricated according as detailed in FIG. 8, using an Autolab PGSTAT12 potentiostat/galvanostat (Eco Chemie, Netherlands) connected to a home-built multiplexer, controlled by the General Purpose Electrochemical System software (Eco Chemie, Netherlands). The measurements were taken after 112 s.

FIG. 15a is a The chronoamperometric current response of oxidation current versus time for a human sera sample containing 6.3 mM total cholesterol (TC). Currents were at defined time intervals after the application of an oxidation potential of +0.15 V (vs Ag/AgCl reference) was applied to the working electrode on a fully constructed Oxford Biosensors screen printed carbon micro-electrode strip fabricated according as detailed in FIG. 98 using an Autolab PGSTAT12 potentiostat/galvanostat (Eco Chemie, Netherlands) connected to a home-built multiplexer, controlled by the General Purpose Electrochemical System software (Eco Chemie, Netherlands).

FIG. 15b is a Calibration plot of oxidation current versus the triglyceride (TG) concentration for different human sera samples. Currents were recorded after an oxidation potential of +0.15 V (vs Ag/AgCl reference) was applied to the working electrode on a fully constructed Oxford Biosensors screen printed carbon micro-electrode strip fabricated according as detailed in FIG. 9 using an Autolab PGSTAT12 potentiostat/galvanostat (Eco Chemie, Netherlands) connected to a home-built multiplexer, controlled by the General Purpose Electrochemical System software (Eco Chemie, Netherlands). The measurements were taken after 196 s.

1. A reagent device comprising:
one or more discrete reagent modules provided with a reagent substance; and
a receiving station for receiving a respective reagent module positioned onboard the device.

2. A reagent device according to claim 1, wherein the discrete reagent module comprises a discrete structure incorporated in the reagent device.

3. A reagent device according to claim 1 or claim 2, wherein the reagent module is incorporated in the reagent device structure with solid form reagent substance present in the respective module.

4. A reagent device according to any preceding claim, wherein the reagent module comprises a receptacle or well.

5. A reagent device according to any preceding claim, wherein the reagent module includes an electrical contact for contacting with an electrode of the reagent device.

6. A reagent device according to any preceding claim, wherein the receiving station comprises a receiving socket formed in the reagent device structure.

7. A reagent device according to any preceding claim, in which the reagent device is an electrochemical electrode sensor device.

8. A reagent device according to any preceding claim, wherein the reagent substance comprises an electro-active substance.

9. A reagent device according to any preceding claim, in which a plurality of discrete reagent modules are provided.

10. A reagent device according to claim 9 in which the reagent modules are provided with means for mating with one another for location or securing with respect to one another (preferably so providing respective receiving stations for receiving the reagent modules positioned onboard the device).

11. A reagent device according to claim 10, wherein the mating means comprise complementary engagement formations on the respective modules.

12. A reagent device according to claim 10 or claim 11 wherein the mating means are interlocking, arranged to prevent mated modules from being separated from one another in a specific separation direction.

13. A reagent device according to any of claims 9 to 12, wherein respective modules include one or more respective reagent zones and an electrode track arrangement.

14. A reagent device according to of claims 9 to 13, wherein first and second modules are provided, each including a strip fragment having an electrode track.

15. A reagent device according to any of claims 9 to 14, wherein each separate module contains a single reagent body only.

16. A reagent device according to any of claims 9 to 15, wherein each separate module contains a respective single receptacle or well only.

17. A reagent device according to any of claims 9 to 16, wherein different respective reagent modules are provided with different variety solid form reagents.

18. A reagent device according to any preceding claim, wherein the device comprises a micro fluidic device configured to receive micro litre fluid volumes (or less) of an investigation sample to be received in the reagent module.

19. A reagent device according to any preceding claim wherein the device includes an investigation sample receiving station.

20. A reagent device according to any preceding claim including a filter arrangement for filtering an investigation sample.

21. A reagent device according to any preceding claim, comprising an electro-chemical electrode biosensor device.

22. A reagent module for use in an electrochemical electrode sensor and comprising a reagent substance in solid form.

23. A reagent module according to claim 22 comprising a receptacle (well) within which the reagent substance is deposited.

24. A reagent module according to claim 22 or claim 23, wherein the reagent module includes electrical contact means for electrical connection with an electrode of the sensor.

25. A method of manufacturing a reagent device comprising positioning one or more discrete reagent modules onboard the device with respect to a respective module receiving station, the reagent module incorporating a reagent substance.

26. A method according to claim 25, wherein the reagent substance is incorporated into the reagent module prior to the module being positioned with respect to the respective receiving station.

27. A method according to claim 25 or claim 26, wherein the reagent substance is introduced to the module in liquid form and subsequently changes to solid form.

28. A method according to claim 27, wherein the reagent substance is introduced to the module in liquid form and subsequently freeze dried.

29. A method according to any of claims 25 to 28, wherein a plurality of separate discrete reagent modules are secured onboard the device, the separate modules incorporating reagent substance.

30. A method according to claim 29, wherein the reagent modules mate or interlock with one another (preferably such that one reagent module provides a receiving station for the other).

31. A method according to claim 29 or 30, wherein each of the modules incorporates a different reagent substance.

32. A method according to any of claims 25 to 31, wherein the reagent substance or substances is or are electro-active substances.

33. A method according to any of claims 25 to 32, wherein the reagent substance is present in a respective module in a micro volume dose in the range 100 nano litres to 1000 nano litres.

34. A method according to any of claims 25 to 33, wherein the reagent substance is present in a respective module in a micro volume dose in the range 300 nano litres to 700 nano litres.

35. A method according to any of claims 25 to 34, wherein the reagent substance is present in a respective module in a micro volume dose in the range 400 nano litres to 600 nano litres.

36. A method according to any of claims 25 to 35, wherein following depositing reagent in the module but before assembling the module onboard the device, the reagent in the module and/or electrical characteristics of the reagent or module are tested.

37. A method of manufacturing a reagent device comprising:
obtaining a discrete solid form dose of a reagent substance from a liquid form starting material (by means of freeze drying, or otherwise);
positioning the discrete solid form reagent dose onboard the device at a receiving station.

38. A method according to claim 37, wherein a plurality of solid form doses of different reagent substances are positioned onboard the device.

39. An electro-chemical biosensor device comprising:
a plurality of discrete reagent modules each provided with a solid form dose of a respective reagent substance, wherein different modules are provided with different reagent substances; and,
respective receiving stations for receiving the reagent modules secured onboard the device.

40. A biosensor according to claim 39 wherein the reagent modules are provided with mating or interlocking formations such that one module provides a receiving station for another.

41. A reagent device or biosensor according to any preceding claim, comprising a reagent well containing a reagent, the well further comprising:
(i) one or more structures internally of the well about which reagent substance is distributed on a wall of the well; and/or
(ii) flow path formulations for directing flow of a substance to react with the reagent into the well.

42. A reagent device or biosensor incorporating a well provided with reagent substance, the well including:
one or more structures internally of the well about which reagent substance is distributed; and/or
(ii) flow path formations (such as one or more grooves or channels) provided on a wall of the well for directing flow a test substance (intended to react with the reagent) into the well.
